(19) United States
(12) Patent Application Publication
(10) Pub. No.: US 2012/0163244 A1
(43) Pub. Date: Jun. 28, 2012

(54) METHOD FOR SUPPORTING NODE MOBILITY IN WIRELESS MESH NETWORK

(75) Inventors: Jung Soo PARK, Daejeon (KR); Hyoung Jun Kim, Daejeon (KR)

(73) Assignee: ELECTRONICS AND TELECOMMUNICATIONS RESEARCH INSTITUTE, Daejeon (KR)

(21) Appl. No.: 13/248,180

(22) Filed: Sep. 29, 2011

(30) Foreign Application Priority Data
Dec. 23, 2010 (KR) 10-2010-0133660

(51) Int. Cl. H04W 36/08; H04W 84/18

(52) U.S. Cl. 370/277; 370/331

(57) ABSTRACT

Provided is a method of data transmission from an access router in a wireless mesh network. The method of data transmission includes: receiving, from a gateway, a broadcast message indicating that a connection to the external internet can be made; establishing a bi-directional path to the gateway;

when a new node is connected to the access router, sending information about the new node to the gateway; if there is a data transmission in which a node located within the coverage area of the access router is a destination node, forwarding the data to the destination node.

### CROSS-REFERENCE TO RELATED APPLICATION

This application claims priority to and the benefit of Korean Patent Application No. 10-201 0-01 33660 filed in the Korean Intellectual Property Office on Dec. 23, 2010, the entire contents of which are incorporated herein by reference.

### BACKGROUND OF THE INVENTION

(a) Field of the Invention

The present invention relates to a wireless mesh network. More particularly, the present invention relates to a method for supporting node mobility in a wireless mesh network.

(b) Description of the Related Art

Wireless networks are being studied as a communication means for various purposes. Particularly, a wireless mesh network is gaining more and more attention, which can provide a wireless connection area within a wide coverage at low cost.

Recently, IETF (Internet Engineering Task Force) and IEEE (Institute of Electrical and Electronics Engineers) have also proposed various techniques for supporting mobility. Accordingly, it is intended to provide high mobility in a wireless mesh network which has been so far applied mainly in a fixed environment.

One example for supporting mobility in a wireless network is IEEE 802.11s routing protocol. The IEEE 802.11s routing protocol is a standard which includes various techniques at layer 2 for a wireless mesh network. HWMP (Hybrid Wireless Mesh Protocol) supporting both reactive and proactive routing techniques are under development. The HWMP protocol uses an RANN (Root Announce) message, a PANN (Portal Announce) message, a PREQ/PREP (Path Request/Reply) message, a PU/PUC (Proxy Update/Proxy Update Ack) message, and so on. Moreover, the HWMP protocol uses STA (Mesh Station), MAP (Mesh Access Point), MPP (Mesh Portal) for individual main functionalities. The Mesh STA is an STA in which a mesh routing protocol operates, and the MAP performs general AP functionality, as well as mesh STA functionality, and may have a general legacy STA at a lower layer. The MPP performs MAP functionality, and may be connected via the internet. The IEEE 802.11s routing protocol may be used as a wireless backbone that replaces a wired backbone, or used for last mile connectivity in a network consisting of optical cables. For example, the IEEE 802.11s routing protocol may be properly used to configure a new network around streetlights, traffic lights, bus stops, etc. At this point, there is a need to extend the IEEE 802.11s routing protocol to a technique for supporting a mobile device of a vehicle or the like.

Another example for supporting mobility in a wireless network includes a mobile IPv6 (Proxy Mobile Internet Protocol version 6, PMIPv6) protocol (RFC5213). MIPv6 (RFC3775) functionality is achieved by a mobile node (MN) supporting IP mobility, and provides handover when moving from one AR (Access Router) to another AR. On the other hand, FMIPv6 (Fast Handover Mobile IPv6, RFC5568) functionality is intended to improve handover performance in terms of handover delay and packet loss, and improves MIPv6. In this way, MIPv6 and FMIPv6 demand the participation of a node for mobility related signaling. In contrast, PMIPv6 (RFC5213) functionality provides an IP mobility service to a node not having the MIPv6 functionality, as well as a node having the MIPv6 functionality. As the performance of PMIPv6 is considered in terms of handover delay and packet loss, MIPv6 is no different from MIPv6.

PMIPv6 provides mobility at layer 3, and does not demand the participation of a node for mobility related signaling. That is, all mobility related processes are carried out in a network, such as a MAG (Mobile Access Gateway) and an LMA (Local Mobility Anchor). MAG maintains information about moving nodes in a Binding Update List (BUL). LMA manages information about all nodes in a PMIPv6 domain in a BCE (Binding Cache Entry), and performs the functionalities, such as allocation of addresses to nodes, proper routing of data packets, and so on. A PBU/PBA (Proxy Binding Update/Acknowledgement) message may be used for communication between MAP and LMA.

In this way, although PMIPv6 supports mobility without any modifications in terms of layer 3 of a terminal, it may require help from other layers in order to support higher mobility.

Still another example for supporting mobility in a wireless network is PFMIPv6 (Proxy Fast Handover Mobile IPv6, RFC5949). PFMIPv6 suggests a method for using FMIv6 under an environment where PMIPv6 is used as a mobility management protocol. That is, there is suggested a method for supporting several mobility service scenarios when a node does not have IP mobility functionality. PFMIPv6 can provide fast handover function by sharing information between MAGs before a node moves.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a high mobility support method, which is associated with a proxy mobility support method under a wireless mesh network environment of layer 2.

An exemplary embodiment of the present invention provides a method of data transmission from an access router in a wireless mesh network, the method including: receiving, from a gateway, a broadcast message indicating that a connection to the external internet can be made; establishing a bi-directional path to the gateway; when a new node is connected to the access router, sending information about the new node to the gateway; if there is a data transmission in which a node located within the coverage area of the access router is a destination node, forwarding the data to the destination node.

An exemplary embodiment of the present invention provides a method for a first access router to support the mobility of a second access router in a wireless mesh network, the method including: receiving, from the second access router, a notification that an entire small scale network managed by the second access router will move to the coverage area of a new access router, i.e., third access router; notifying the third access router that the small scale network managed by the second access router will move to the coverage area of the third access router; and providing the third access router with information about nodes managed by the second access router.

An exemplary embodiment of the present invention provides a method for a first access router to support the mobility of a second access router in a wireless mesh network, the method including: receiving, from a third access router, a message indicating that an entire small scale network managed by the second access router currently within the coverage area of the third access router will move to the coverage area of the first access router; receiving information about nodes managed by the second access router from the third access router; receiving a connection request from the second access router; and transmitting an acknowledgment of the information about the nodes to the third access router.

### BRIEF DESCRIPTION OF THE DRAWINGS

FIG. 1 is a view showing a structure of a PMIPv6 (Proxy Mobile Internet Protocol version 6)-based wireless mesh network for providing a mobility service according to an exemplary embodiment of the present invention.

FIG. 2 is a flowchart showing a communication procedure in a fixed environment in the wireless mesh network of FIG. 1 according to an exemplary embodiment of the present invention.

FIG. 3 is a flowchart showing a data transmission procedure in a wireless mesh network supporting intra domain mobility according to an exemplary embodiment of the present invention.

FIG. 4 is a flowchart showing a data transmission procedure in a wireless mesh network supporting inter domain mobility according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

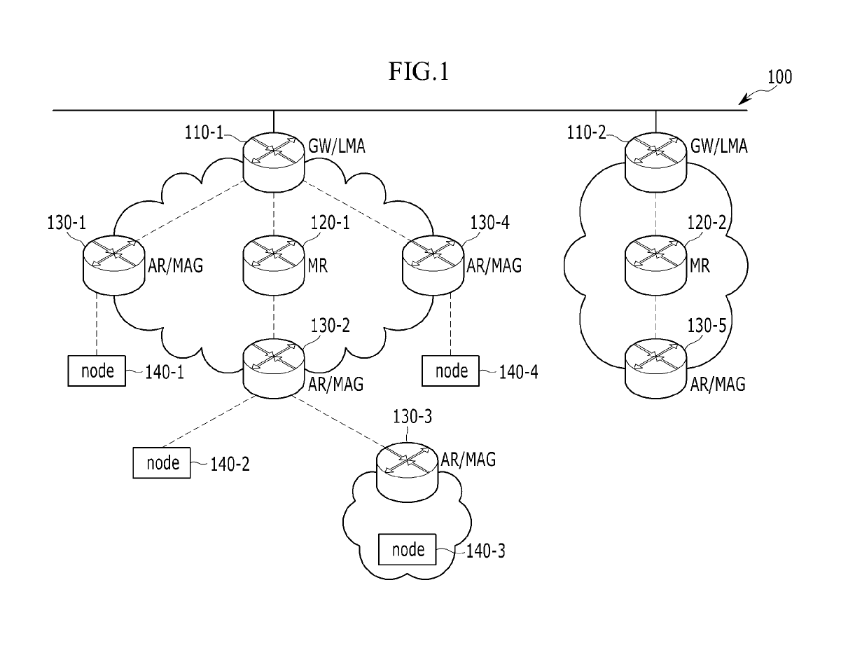

FIG. 1 is a view showing a structure of a PMIPv6 (Proxy Mobile Internet Protocol version 6)-based wireless mesh network for providing a mobility service according to an exemplary embodiment of the present invention. The PMIPv6 protocol refers to a network-based mobility management technique for managing the mobility of a node in an access network so that an existing established connection is continuously maintained even if a node not implementing the MIPv6 (Mobile IPv6) functionality is moved.

Referring to FIG. 1, the PMIPv6-based wireless mesh network is based on the IEEE 802.11s protocol at layer 2, and based on the PMIPv6 protocol and the PFMIPv6 (Proxy-based Fast Handover Mobile IPv6) protocol at layer 3.

The PMIPv6-based wireless mesh network 100 comprises a GW/LMA (Gateway/Local Mobility Anchor) 110-1 and 110-2, MRs (Mesh Routers) 120-1 and 120-2, ARs/MAGs (Access Routers/Mobile Access Gateways) 130-1, 130-2, 130-3, 130-4, and 130-5, and nodes 140-1, 140-2, 140-3, and 140-4.

The GW of the GW/LMA 110-1 and 110-2 performs both the function of MPP (Mesh Portal) at layer 2 and the function of a router at layer 3. The MRs 120-1 and 120-2 perform both the function of a mesh station (STA) at layer 2 and the function of a router at layer 3.

The ARs of ARs/MAGs 130-1, 130-2, 130-3, 130-4, and 130-5 perform both the function of an MAP at layer 2 and the function of a router at layer 3. Here, the ARs may be divided into a Static AR (sAR) and a moving AR (mAR) according to the presence or absence of mobility.

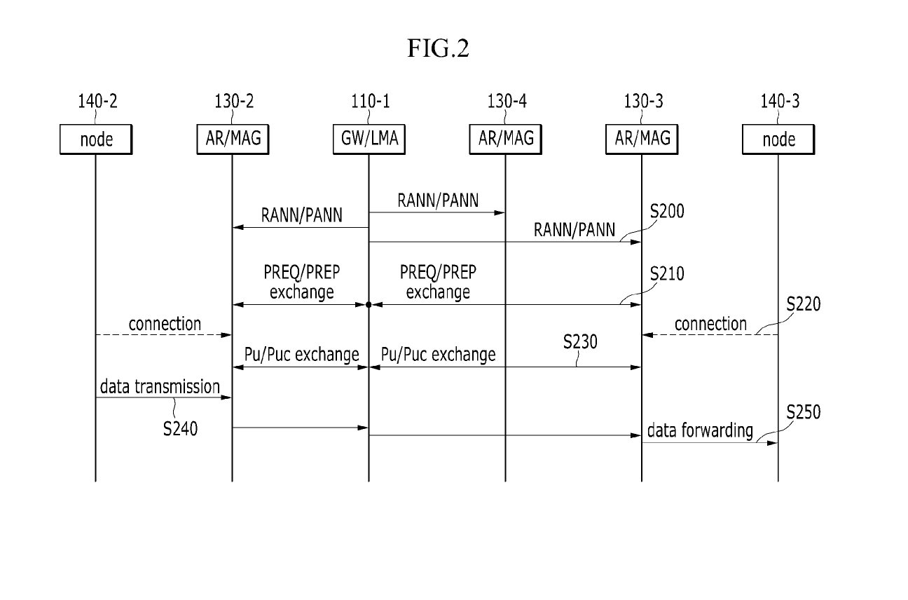

The nodes 140-1, 140-2, 140-3, and 140-4 refer to terminals. FIG. 2 is a flowchart showing a communication procedure in a fixed environment in the wireless mesh network of FIG. 1 according to an exemplary embodiment of the present invention.

Referring to FIG. 2, the GW/LMA 110-1 broadcasts an RANN (Root Announce) message a PANN (Portal Announce) message into the network (S200). The RANN message indicates that the GW/LMA 110-1 serves as a root MPP within the wireless mesh network 100. The PANN message indicates that the GW/LMA 110-1 serves as an MPP. The GW/LMA 110-1 hereby notifies that a connection to the external internet can be made via itself.

Meanwhile, in terms of layer 3, the GW/LMA 110-1 is able to notify that it serves an LMA through the RANN message.

The AR/MAG 130-2 and the AR/MAG 130-3 having received the RANN message and the PANN message establish a bi-directional path with the GW/LMA 110-1 by transmitting a PREQ (Path Request) message to the GW/LMA 110-1 and receiving a PREP (Path Reply) message from the GW/LMA 110-1 (S210).

Afterwards, the node 140-2 and the node 140-3 are respectively connected to the AR/MAG 130-2 and the AR/MAG 130-3 (S220). A connection point between a node and an AR/MAG can be referred to as a PoA (Point of Attachment).

When a new node is connected within the coverage area of the AR/MAG 130-2 and AR/MAG 130-3, the AR/MAG 130-2 and the AR/MAG 130-3 notify the GW/LMA 110-1 of the presence of a connected node (S230).

This process can be carried out by means of the exchange of a PU message and a PUC message between the AR/MAG 130-2 and AR/MAG 130-3 and the GW/LMA 110-1. The GW/LMA 110-1 can hereby detect of which AR/MAG legacy nodes are under the control.

If the node 140-2 wants to transmit data to the node 140-3, the node 140-2 transmits data to the AR/MAG 130-2 (S240). If the AR/MAG 130-2 is aware of the presence of the node 140-3, it forwards the data directly to the node 140-3. If the AR/MAG 130-2 is not aware of the presence of the node 140-3, it broadcasts a PREQ message into the network.

Having received the PREQ message, the AR/MAG 130-3 recognizes the PREQ message as being directed to the node 140-3 controlled by itself. Hereupon, the AR/MAG 130-2 finds out a path directed to the node 140-3, and forwards the data transmitted from the node 140-2 to the node 140-3 (S250).

Meanwhile, the GW/LMA sets an IPv6 address of the legacy nodes controlled by the ARs/MAGs managed by itself. To this end, each GW/LMA has an IPv6 address block, and is able to recognize which IPv6 address blocks are allocated to which GWs/LMAs.

Each GW/LMA can manage address blocks divided between sAR/MAG and mAR/MAG. Accordingly, the GW/LMA identifies nodes belonging to a moving AR, and provides an efficient mobility service. Also, the GW/LMA is able to discriminate between intra domain mobility for mobility inside a domain from an address and inter domain mobility for mobility out of a domain.

Hereinafter, a wireless mesh network supporting intra domain mobility will be described. Intra domain mobility means that the entire small scale network of FIG. 1 under the control of the AR/MAG 130-2 and under the management of the AR/MAG 130-3 moves to the coverage area of the AR/MAG 130-4. If the entire small scale network is mounted on a vehicle, such intra domain mobility may occur.

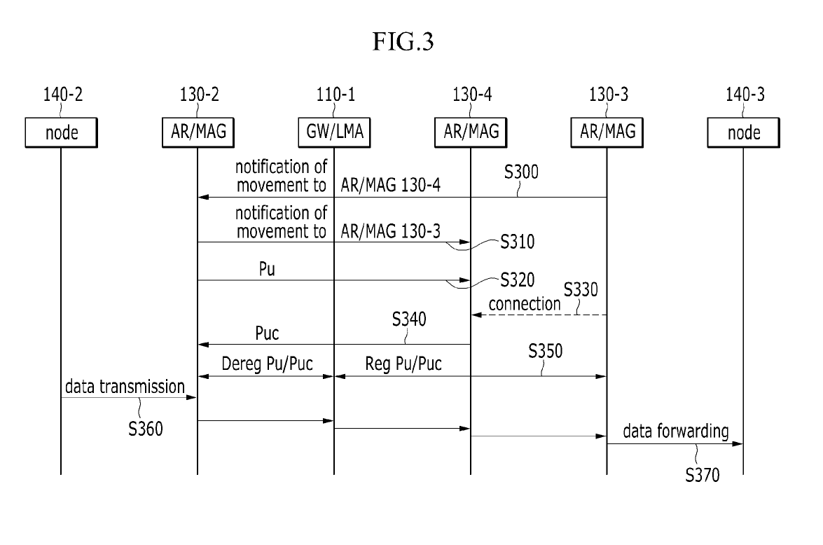

FIG. 3 is a flowchart showing a data transmission procedure in a wireless mesh network supporting intra domain mobility according to an exemplary embodiment of the present invention. It is assumed that the AR/MAG 130-3, which has been under the control of the AR/MAG 130-2, moves to the coverage area of the AR/MAG 130-4.

Referring to FIG. 3, the AR/MAG 130-3 notifies the AR/MAG 130-2 that the entire small scale network managed by itself will move to the coverage area of the AR/MAG 130-4 (S300). To this end, a message according to IEEE 802.11s or IEEE 802.11r can be used at layer 2, and a message according to the PFMIPv6 protocol can be used at layer 3. Although which to choose between layer 2 and layer 3 depends on user and network policies, errors can be compensated for by using layer 2 preferentially or using layer 2 and layer 3 together.

The AR/MAG 130-2 notifies the AR/MAG 130-4 that the AR/MAG 130-3 and its small scale network will move (S310). At this point, the AR/MAG 130-2 can provide the AR/MAG 130-4 with information about all the nodes (e.g., the node 140-3) managed by the AR/MAG 130-3 through a PU message (S320).

Afterwards, the AR/MAG 130-3 is connected to the AR/MAG 130-4 (S330), and the AR/MAG 130-4 transmits a PUC message to the AR/MAG 130-2 (S340). If a predetermined length of time is elapsed after the AR/MAG 130-4 receives the PU message from the AR/MAG 130-2, the AR/MAG 130-2 and the AR/MAG 130-4 may carry out again an exchange procedure of the PU message and the PUC message.

Alternatively, the GW/LMA 110-1 instructs the AR/MAG 130-2 to exclude the AR/MAG 130-3 and its small scale network from the coverage area by the exchange procedure of the PU message and the PUC message, and notifies the AR/MAG 130-4 that the AR/MAG 130-3 and its small scale network have entered the coverage area by the exchange procedure of the PU message and the PUC message (S350).

At this point, the PU message may include the MAC (Medium Access Control) address of the AR/MAG 130-4, as well as the MAC address of the AR/MAG 130-3. Moreover, the PU message may include a flag indicating whether the AR/MAG 130-3 is an sAR or mAR.

If the node 140-2 wants to transmit data to the node 140-3, the node 140-2 transmits data to the AR/MAG 130-2 (S360), and the AR/MAG 130-2 forwards the data transmitted from the node 140-2 to the node 140-3 (S370). The data transmission procedure used herein may conform to the IEEE 802.11s protocol of layer 2.

Hereinafter, a wireless mesh network supporting inter domain mobility will be described. Inter domain mobility means that the entire small scale network of FIG. 1, for example, under the control of the AR/MAG 130-4 connected to the GW/LMA 110-1 and under the management of the AR/MAG 130-3 moves to the coverage area of the AR/MAG 130-5 connected to the GW/LMA 110-2. If the entire small scale network is mounted on a vehicle, such inter domain mobility may occur.

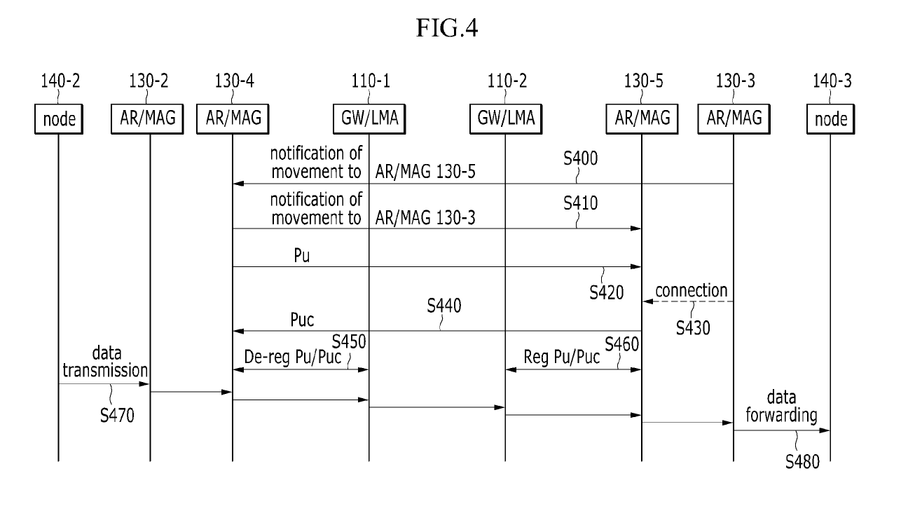

FIG. 4 is a flowchart showing a data transmission procedure in a wireless mesh network supporting inter domain mobility according to an exemplary embodiment of the present invention. It is assumed that the AR/MAG 130-3, which has been under the control of the AR/MAG 130-4, moves to the coverage area of the AR/MAG 130-5. Since this involves the movement from the GW/LMA 110-1 to the GW/LMA 110-2, the PFMIPv6 protocol of layer 3 may be applied to support this movement.

Referring to FIG. 4, the AR/MAG 130-3 notifies the AR/MAG 130-4 that the entire small scale network managed by itself will move to the coverage area of the AR/MAG 130-5 (S400).

The AR/MAG 130-4 notifies the AR/MAG 130-5 that the AR/MAG 130-3 and its small scale network will move (S410). At this point, the AR/MAG 130-4 can provide the AR/MAG 130-5 with information about all the nodes (e.g., the node 140-3) managed by the AR/MAG 130-3 through a PU message (S420).

Afterwards, the AR/MAG 130-3 is connected to the AR/MAG 130-5 (S430), and the AR/MAG 130-5 transmits a PUC message to the AR/MAG 130-4 (S440). If a predetermined length of time is elapsed after the AR/MAG 130-5 receives the PU message from the AR/MAG 130-4, the AR/MAG 130-4 and the AR/MAG 130-5 may carry out again an exchange procedure of the PU message and the PUC message.

Alternatively, the GW/LMA 110-1 instructs the AR/MAG 130-4 to exclude the AR/MAG 130-3 and its small scale network from the coverage area by the exchange procedure of the PU message and the PUC message (S450), and notifies the AR/MAG 130-5 that the AR/MAG 130-3 and its small scale network have entered the coverage area by the exchange procedure of the PU message and the PUC message (S460).

At this point, the PU message may include the MAC (Medium Access Control) address of the AR/MAG 130-5, as well as the MAC address of the AR/MAG 130-3. Moreover, the PU message may include a flag indicating whether the AR/MAG 130-3 is an sAR or mAR.

If the node 140-2 wants to transmit data to the node 140-3, the node 140-2 transmits data to the AR/MAG 130-2 (S470), and the AR/MAG 130-2 forwards the data transmitted from the node 140-2 to the node 140-3 (S480).

According to an exemplary embodiment of the present invention, it is possible to provide a seamless communication service to moving nodes mounted in a vehicle by supporting mobility in a wireless mesh network.

The exemplary embodiments of the present invention described above are not only implemented by the method and apparatus, but it may be implemented by a program for executing the functions corresponding to the configuration of the exemplary embodiment of the present invention or a recording medium having the program recorded thereon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of data transmission from an access router in a wireless mesh network, the method comprising:
receiving, from a gateway, a broadcast message indicating that a connection to the external internet can be made;
establishing a bi-directional path to the gateway;
when a new node is connected to the access router, sending information about the new node to the gateway;
if there is a data transmission in which a node located within the coverage area of the access router is a destination node, forwarding the data to the destination node.

2. The method of claim 1, wherein the gateway performs both the function of MPP (Mesh Portal) at layer 2 and the function of a router at layer 3.

3. The method of claim 1, wherein the gateway stores address information of nodes within the coverage area of the access router.

4. The method of claim 3, wherein the gateway separately stores address information of nodes within the coverage area of a static access router having no mobility and address information of nodes within the coverage area of a moving access router having mobility.

5. The method of claim 1, wherein the access router performs both the function of an MAP (Mesh Access Point) at layer 2 and the function of a router at layer 3.

6. The method of claim 1, wherein the access router is divided into a static access router and a moving AR according to the presence or absence of mobility.

7. The method of claim 1, wherein the establishing of a bi-directional path comprises:
transmitting a Path Request message to the gateway; and
receiving a Path Reply message from the gateway.

8. The method of claim 1, wherein the sending of information about the new node comprises:
transmitting a Proxy Update (PU) message to the gateway; and
receiving a Proxy Update Ack (PUC) message from the gateway.

9. A method for a first access router to support the mobility of a second access router in a wireless mesh network, the method comprising: and
receiving, from the second access router, a notification that an entire small scale network managed by the second access router will move to the coverage area of a new access router, i.e., third access router;
notifying the third access router that the small scale network managed by the second access router will move to the coverage area of the third access router;
providing the third access router with information about nodes managed by the second access router.

10. The method of claim 9, wherein the first access router and the third access router are under the control of the same gateway.

11. The method of claim 9, wherein the first access router and the third access router are under the control of different gateways.

12. The method of claim 9, further comprising receiving, from the gateway for controlling the first access router, a message instructing that the second access router and the small scale network managed by the second access router should be excluded from the coverage area.

13. A method for a first access router to support the mobility of a second access router in a wireless mesh network, the method comprising:
receiving, from a third access router, a message indicating that an entire small scale network managed by the second access router currently within the coverage area of the third access router will move to the coverage area of the first access router;
receiving information about nodes managed by the second access router from the third access router;
receiving a connection request from the second access router; and
transmitting an acknowledgment of the information about the nodes to the third access router.

14. The method of claim 13, wherein the first access router and the third access router are under the control of the same gateway.

15. The method of claim 13, wherein the first access router and the third access router are under the control of different gateways.

16. The method of claim 13, further comprising receiving, from the gateway for controlling the first access router, a message indicating that the second access router and the small scale network managed by the second access router have entered the coverage area of the first access router.

17. The method of claim 16, wherein the message indicative of the entry includes the MAC (Medium Access Control) address of the second access router.

18. The method of claim 17, wherein the message indicative of the entry includes a flag indicating the presence or absence of mobility of the second access router.
